(19) United States
(12) Patent Application Publication
(10) Pub. No.: US 2017/0177670 A1
(43) Pub. Date: Jun. 22, 2017

(54) DATABASE QUERYING APPARATUSES, METHODS FOR QUERYING A DATABASE, AND NON-TRANSITORY TANGIBLE MACHINE-READABLE MEDIA THEREOF

(71) Applicant: BigObject Inc., Grand Cayman (KY)

(72) Inventors: Wenwey HSEUSH, Grand Cayman (KY); Yu-Chun LAI, Grand Cayman (KY); Yi-Cheng HUANG, Grand Cayman (KY)

(21) Appl. No.: 14/979,126

(22) Filed: Dec. 22, 2015

(51) Int. Cl. G06F 17/30

(52) U.S. Cl. CPC G06F 17/30477; G06F 17/30598

(57) ABSTRACT

Database querying apparatuses, methods for querying a database, and non-transitory tangible machine-readable media thereof are provided. The database querying apparatus includes receives a query including an adjective, an attribute, and a dataset name. The database querying apparatuses is stored with a fact dataset, which is defined with the attribute and at least one data field. The fact dataset includes at least one fact record. Each fact record includes an attribute value corresponding to the attribute and a list of data corresponding to the at least one data field. The database querying apparatuses accesses the fact dataset according to the dataset name, divides the fact dataset into several groups according to the attribute values, apply the operation corresponding to the adjective to each group to derive several sub-results, and generate the final result for the query from the sub-results. The operation corresponds to the adjective.

### CROSS-REFERENCES TO RELATED APPLICATIONS

Not applicable.

### BACKGROUND OF THE INVENTION

Field of the Invention

The present invention relates to database querying apparatuses, methods for querying a database, and non-transitory tangible machine-readable media thereof. More specifically, the present invention relates to database querying apparatuses, methods for querying a database, and non-transitory tangible machine-readable media thereof that a query is achieved by finding insightful information for the interested entities from a dataset using an adjective, a describing word developed in a process of concept formation based on fact patterns, common properties or previously developed adjectives.

Descriptions of the Related Art

With the rapid development in computer technologies, most enterprises collect, store, manipulate, and organize every kind of information/data in computers in a systematic way. Relational databases, on-line analytical processing (OLAP), and recently NoSQL database are examples of commonly adopted technologies.

Although various commercial and open-sourced products of relational databases, OLAP, and NoSQL database have been developed, user cannot easily find out the insight or the pattern of huge amount of data stored in these databases via the provided query languages. The most prominent query language is Structured Query Language (SQL), which has been developed since 70's. Most databases today adopt SQL or SQL-like query languages, wherein data are often expressed and examined on record level. Beside group-by function and basic statistic variables such as sum, mean or standard deviation, the support of group-level query (or entity-level query) by databases is limited. In the presence of big data, what people are interested in is the insightful information for the entities or groups rather than individual fact records. SQL is capable of defining how to group data by entities or attributes, but fails to describe the characteristics or patterns for the entities or groups. A group-level query is to find out the interested entities or groups, wherein member records are matched against the desired data pattern. It may specify a complex data pattern which is difficult to express in SQL or a SQL-like query language. Without sufficient support of group-level or entity-level query, the traditional approach to finding group-level insights comes with no choice but to pull all needed records out of the database into program data structures for processing. User Defined Functions (UDF) or Stored Procedures, supported in many databases to run on database servers, falls into the same paradigm wherein all needed data records are pull out of the database store in SQL. Such pull approach becomes difficult in both implementation and performance while the size of data is growing big. Therefore, in the presence of big data, it is an urgent need for a querying mechanism that can easily express complex data patterns in a high-level manner, and find out the interested entities or groups that meet the specified data patterns.

### SUMMARY OF THE INVENTION

An objective of the present invention is to provide a database querying apparatus. The database querying apparatus comprises a transceiving interface, a storage unit, and a processor, wherein the processor is electrically connected to the storage unit and the transceiving interface. The transceiving interface is configured to receive a query, wherein the query comprises an adjective, an attribute, and a dataset name. The storage unit is stored with a fact dataset, wherein the fact dataset is defined with the attribute and at least one data field. The fact dataset comprises at least one fact record. Each of the at least one fact record comprises an attribute value corresponding to the attribute and a list of data corresponding to the at least one data field. The processor is configured to access the fact dataset according to the dataset name and divide the fact dataset into a plurality of groups according to a mapping of the attribute values one-on-one. The mapping of the attribute values is a function that maps the domain of attribute values to a fixed set of values. The processor is further configured to apply an operation to each group to derive a list of sub-results, wherein the operation corresponds to the adjective in the query. The processor is further configured to generate the final result for the query from the sub-results. The operation corresponding to the adjective is a function of a data pattern or a logical expression of pre-defined adjectives.

Another objective of the present invention is to provide a method for querying a database, wherein the method is for use in an electronic apparatus. The method comprises the following steps of: (a) receiving a query, wherein the query comprises an adjective, an attribute, and a dataset name, (b) accessing a fact dataset in the database according to the dataset name, wherein the fact dataset is defined with the attribute and at least one data field, the fact dataset comprises at least one fact record, each of the at least one fact record comprises an attribute value corresponding to the attribute and a list of data corresponding to the at least one data field, (c) dividing the fact dataset into a plurality of groups according to a mapping of the attribute values one-on-one, (d) applying an operation to each group to derive a list of sub-results, wherein the operation corresponds to the adjective, and (e) generating the final result for the query from the sub-results. The operation corresponding to the adjective is a function of a data pattern or a logical expression of pre-defined adjectives.

Yet a further objective of the present invention is to provide a non-transitory tangible machine-readable medium, which is stored with a computer program. The computer program comprises a plurality of codes, wherein the codes are able to execute a method for querying a database when the computer program is loaded into an electronic apparatus. The method comprises the steps of: (a) receiving a query, wherein the query comprises an adjective, an attribute, and a dataset name, (b) accessing a fact dataset in the database according to the dataset name, wherein the fact dataset is defined with the attribute and at least one data field, the fact dataset comprises at least one fact record, each of the at least one fact record comprises an attribute value corresponding to the attribute and a list of data corresponding to the at least one data field, (c) dividing the fact dataset into a plurality of groups according to a mapping of the attribute values one-on-one, (d) applying an operation to each group to derive a list of sub-results, wherein the operation corresponds to the adjective, and (e) generating the final result for the query from the sub-results. The operation corresponding to the adjective is a function of a data pattern or a logical expression of pre-defined adjectives.

The present invention provides database querying apparatuses, methods for querying a database, and non-transitory tangible machine-readable media thereof that a query is achieved by utilizing an adjective, a describing word developed in a process of concept formation, based on fact patterns, common properties and previously developed adjectives. Generally speaking, a query in the present invention comprises at least an adjective, an attribute, and a table dataset name. Depending on the user's requirement, a query may further comprise other attribute(s), a designated quantity, a designated attribute value, attribute conditions, etc. The present invention presents a way to describe interested groups or entities with an adjective that is defined as a function of data pattern or a logical expression of pre-defined adjectives, and apply the corresponding operation to the database to identify the interested. Since adjectives are describing words that are straightforward to human beings, it is intuitive and easy for a user to specify an adjective-describing query to find out insightful information from database.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A illustrates the schematic view of a database querying apparatus 1 of the first embodiment;

FIG. 1B illustrates the content of the fact dataset 10;

FIG. 2 illustrates the flowchart of the method for querying a database of the second embodiment; and

FIG. 3 illustrates the flowchart of the method for querying a database of the third embodiment.

### DESCRIPTION OF THE PREFERRED EMBODIMENT

In the following descriptions, database querying apparatuses, methods for querying a database, and non-transitory tangible machine-readable media thereof of the present invention will be explained with reference to embodiments thereof. However, these embodiments are not intended to limit the present invention to any specific environment, applications, or particular implementations described in these embodiments. Therefore, description of these embodiments is only for purpose of illustration rather than to limit the present invention. It should be appreciated that elements unrelated to the present invention are omitted from depiction in the following embodiments and the attached drawings.

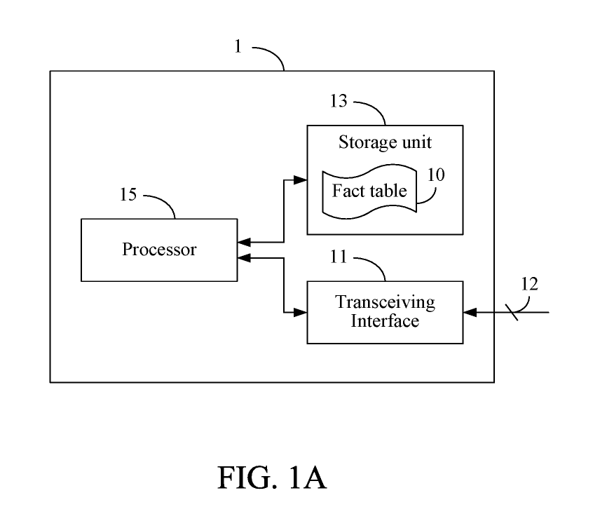

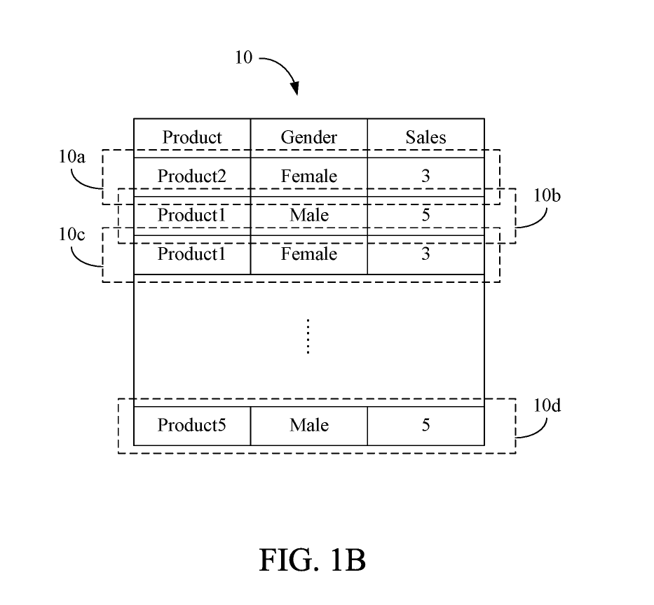

A first embodiment of the present invention is a database querying apparatus 1 and a schematic view of which is illustrated in FIG. 1A. The database querying apparatus 1 comprises a transceiving interface 11, a storage unit 13, and a processor 15, wherein the processor 15 is electrically connected to the transceiving interface 11 and the storage unit 13. The transceiving interface 11 may be any interface that can receive an instruction according to the control of a user. The storage unit 13 may be a memory, a floppy disk, a hard disk, a compact disk (CD), a mobile disk, a magnetic tape, a database stores accessible to networks, or any other storage media with the same function and well-known to those of ordinary skill in the art or a circuit. The processor 15 may be any of various processors, central processing units (CPUs), microprocessors, or other computing devices well known to those of ordinary skill in the art.

The storage unit 13 is stored with a fact dataset 10. For convenience, it is assumed that the dataset name of the fact dataset 10 is “xyz,” which, however, is not used to limit the scope of the present invention. The content of the fact dataset 10 is illustrated in FIG. 1B. The fact dataset 10 is defined with two attributes (i.e. “Gender” and “Product”) and a data field (i.e. “Sales”). It is noted that the present invention does not limit the number of the attributes that a fact dataset is defined with as long as the number is greater than or equal to one. The fact dataset 10 comprises a plurality of fact records 10a, 10b, 10c, . . . , 10d, wherein each of the fact records 10a, 10b, 10c, . . . , 10d comprises two attribute values corresponding to the two attributes respectively. In addition, each of the fact records 10a, 10b, 10c, . . . , 10d comprises a list of data corresponding to the data field. It is noted that the present invention does not limit the number of the fact records comprised in a fact dataset.

In this embodiment, a user can query the fact dataset 10 by utilizing an adjective. Please note that an adjective is a describing word and the main syntactic roles of an adjective include qualifying a noun or noun phrase and giving more information about the object signified. The significance of using an adjective in a query is that adjectives provide meanings to human beings, such as the term “important,” the term “significant,” and the term “odd.” Therefore, having a query containing an adjective is more straightforward to users, e.g. “find 100 critical subject from posting”, “find 100 important user from xyz” and “find 100 significant product in gender from xyz.” Such an adjective is defined by a function of a data pattern or a logical expression of pre-defined adjectives, e.g., “critical” defined as “urgent and important” and both “important” and “urgent” defined by specific data patterns.

Please also note that the adjective is defined by a function of one of a data pattern and a logical expression of pre-defined adjectives. The operation corresponding to the adjective is one of the function and the defined expression. The function takes a group of data as input and computes and returns a value, wherein the value is one of a Boolean, an integer, and any measurable value, and the logical expression includes one of an AND, OR, NOT, and comparison operators and the combination thereof.

In this embodiment, when a user intends to query data (or find the insight of the data) stored in the database querying apparatus 1, he or she inputs a query 12 comprising at least an adjective, an attribute, and a dataset name. For example, if the query received by the transceiving interface 11 is “find 100 significant product from xyz,” the adjective comprised in the query 12 is “significant,” the attribute comprised in the query 12 is “product,” and the dataset name comprised in the query 12 is “xyz.” In response to the input of the user, the transceiving interface 11 receives the query 12. The query is to find out 100 significant products from the dataset “xyz”. The adjective “significant” is defined by a data pattern that meets statistic property of significance.

The processor 15 accesses the fact dataset 10 according to the dataset name (i.e. “xyz”) comprised in the query 12. The processor 15 divides the fact dataset 10 into a plurality of groups according to the attribute values corresponding to the attribute comprised in the query 12 so that the groups correspond to a mapping of the distinct attribute values one-on-one. For example, if the attribute comprised in the query 12 is “product,” there will be a group comprising the fact record(s) having the attribute value “Product1,” a group comprising the fact record(s) having the attribute value “Product2,” . . . , and a group comprising the fact record(s) having the attribute value “Product5.” In this embodiments, an adjective corresponds to an operation provided by the database querying apparatus 1. The processor 15 identifies the operation from a set of pre-defined operations according to the adjective comprised in the query 12. Afterwards, the processor 15 applies the operation to each group to derive a list of sub-results. After that, the processor 15 generates the final result for the query 12 from the sub-results. It will return 100 products which meet the quality of “significant.” To provide a clear picture of this embodiment, several examples are given below.

In the first example, the content of the query 12 is “find important product from xyz.” The adjective comprised in the query 12 is “important,” the attribute comprised in the query 12 is “product,” and the dataset name comprised in the query 12 is “xyz.” The processor 15 divides the fact dataset 10 into a plurality of groups according to the attribute values “Product1,” “Product2,” . . . , “Product5” so that there will be a group comprising the fact record(s) having the attribute value “Product1,” a group comprising the fact record(s) having the attribute value “Product2,” . . . , and a group comprising the fact record(s) having the attribute value “Product5.” Then, the processor 15 applies the operation corresponding to the adjective “important” to each of the groups and generates a sub-result for each of the groups. For convenience, it is assumed in this example that the operation corresponding to the adjective “important” generates a sub-result of “Yes” or “No” after being applied to each of the groups. After that, the processor 15 generates the final result for the query 12 from the sub-results. For example, the processor 15 may generates the result according to the sub-results that have the value “Yes” so that the result contains fact records comprised in the group(s) whose sub-result is of the value “Yes.”

In the second example, the content of the query 12 is “find 2 significant product from xyz.” The query 12 comprises an adjective, a designated quantity, an attribute, and a dataset name, wherein the adjective is “significant,” the designated quantity is 2, the attribute is “product,” and the dataset name is “xyz.” Like the first example, the processor 15 divides the fact dataset 10 into a plurality of groups according to the attribute values “Product1,” “Product2,” . . . , “Product5.” Then, the processor 15 applies the operation corresponding to the adjective “significant” to each of the groups and generates a sub-result for each of the groups. In this example, for each of the groups, the operation corresponding to the adjective “significant” generates a sub-result of a value after being applied to that group. In other words, the sub-results correspond to the groups one-on-one and each of the sub-results comprises a value for the corresponding group (i.e. for the corresponding attribute value). After that, the processor 15 generates the final result for the query 12 according to the designated quantity and the values corresponding to the groups. The result comprises a plurality of selected attribute values, each of the selected attribute values is one of the first attribute values, and a quantity of the selected attribute values is equal to the designated quantity. To be more specific, the content of the query 12 is “find 2 significant product from xyz” in this example, so the processor 15 selects the attribute values (e.g. “Product2” and “Product5”) whose corresponding values are the greatest two as the selected attribute values. That is, the result of the query 12 comprises the selected attribute values (e.g. “Product2” and “Product5”) and may further comprise the values corresponding to the selected attribute values.

In the third example, the content of the query 12 is “find 2 significant product in gender from xyz.” The query 12 comprises an adjective, a designated quantity, a first attribute, a second attribute, and a dataset name, wherein the adjective is “significant,” the designated quantity is 2, the first attribute is “product,” the second attribute is “gender,” and the dataset name is “xyz.” In this example, the two attributes comprised in the query 12 has a sequence, which is the first attribute being prior to the second attribute. The processor 15 divides the fact dataset 10 into a plurality of groups according to the first attribute values “Product1,” “Product2,” . . . , “Product5” and then divides each of the groups according to the second attribute values “Female” and “Male.” The rest operations performed by the processor 15 in this example are similar to those described in the second example; hence, the details are not repeated. Please note that the purpose of giving this example is to demonstrate that a query may comprise several attributes.

In the fourth example, the content of the query 12 is “find 2 similar product in gender with “Product5” from xyz.” The query 12 comprises an adjective, a designated quantity, a first attribute, a second attribute, a designated attribute value, and a dataset name, wherein the adjective is “similar,” the designated quantity is 2, the first attribute is “product,” the second attribute is “gender,” the designated attribute value is “Product5,” and the dataset name is “xyz.” It is noted that the designated attribute value is one of the first attribute values. Similar to the third example, the two attributes comprised in the query 12 has a sequence, which is the first attribute being prior to the second attribute. The processor 15 divides the fact dataset 10 into a plurality of groups according to the first attribute values “Product1,” “Product2,” . . . , “Product5” and then divides each of the groups according to the second attribute values “Female” and “Male.” The processor 15 identifies the operation corresponding to the adjective “similar.” After that, the processor 15 applies the operation corresponding to the adjective “similar” to the groups by identifying one of the groups as a designated group according to the designated attribute value and applying the operation to each of a plurality of pairs of groups, wherein each pair of the groups is formed by the designated group and one of the rest groups. To be more specific, the processor 15 identifies the group corresponding to the first attribute value “Product5” as the designated group according to the designated attribute value of the query 12 and then applying the operation corresponding to the adjective “similar” to the pairs of groups, including a pair of “Product5” and “Product1,” a pair of “Product5” and “Product2,” etc. In this example, for each of the pairs of groups, the processor 15 generates a sub-result after applying the operation to that pair. The sub-result indicates the degree of the similarity between the two groups. Afterwards, the processor 15 generates the final result for the query from the sub-results.

According to the above descriptions, a user can query data (or find the insight of the data) stored in the database querying apparatus 1 by an adjective. A query for the database querying apparatus 1 comprises at least an adjective, an attribute, and a dataset name. Depending on the user's requirement, a query may further comprise other attribute(s), a designated quantity, a designated attribute value, etc. Since adjectives are more straightforward, users can query data (or find the insight of the data) stored in the database querying apparatus 1 more conveniently and easily.

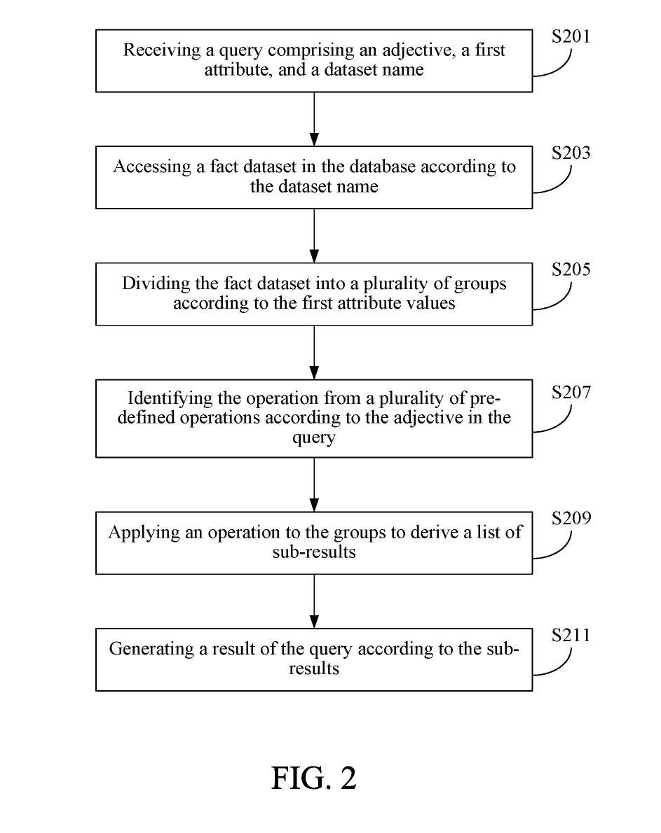

A second embodiment of the present invention is a method for querying a database and a flowchart of which is illustrated in FIG. 2. The method is for use in an electronic apparatus, such as the database querying apparatus 1 in the first embodiment. The database may be stored in the database querying apparatus 1 or a space external to the database querying apparatus 1.

First, step S201 is executed by the electronic apparatus for receiving a query, wherein the query comprises an adjective, a first attribute, and a dataset name. For example, the content of the query received in step S201 is “find important product from xyz.” The adjective comprised in the query is “important,” the attribute comprised in the query is “product,” and the dataset name comprised in the query is “xyz.” Next, step S203 is executed by the electronic apparatus for accessing a fact dataset in the database according to the dataset name in the query. The fact dataset is defined with the first attribute and a data field and comprises at least one fact record. Each of the at least one fact record comprises a first attribute value corresponding to the first attribute and a list of data corresponding to the data field. Following that, step S205 is executed by the electronic apparatus for dividing the fact dataset into a plurality of groups according to a mapping of the first attribute values one-on-one.

Step S207 is executed by the electronic apparatus for identifying the operation from a plurality of pre-defined operations according to the adjective in the query. In this embodiment, step S207 is executed after step S205. However, step S207 may be executed prior to step S205 or step S203 in some other embodiments as long as it is executed after step S201. Afterwards, step S209 is executed by the electronic apparatus for applying an operation to each group to derive a list of sub-results, wherein the operation corresponds to the adjective. To be more specific, in step S209, the operation is applied to each of the groups and each of the sub-results is derived from one of the groups. Next, step S211 is executed by the electronic apparatus for generating the final result for the query from the sub-results.

In some other embodiments, the query received in step S201 may comprise an adjective, a designated quantity, a first attribute, and a dataset name. For example, the content of the query received in step S201 may be “find 2 significant product from xyz,” wherein the adjective is “significant,” the designated quantity is 2, the attribute is “product,” and the dataset name is “xyz.” Each of the sub-results derived in step S209 may comprise a value. For those embodiments, step S211 generates the result of the query according to designated quantity and the values. To be more specific, the result comprises a plurality of selected attribute values, each of the selected attribute values is one of the first attribute values, and a quantity of the selected attribute values is equal to the designated quantity.

Yet in some other embodiments, the fact dataset stored in the database may be defined with a plurality of attributes (e.g. a first attribute and a second attribute) and a data field and comprises at least one fact record. Each of the at least one fact record comprises a plurality of attribute values (e.g. a first attribute value and a second attribute value) corresponding to the attributes one-on-one. Each of the at least one fact record also comprises a list of data corresponding to the data field. For those embodiments, the query received in step S201 may comprise an adjective, a first attribute, a second attribute, and a dataset name. For such a query, the method may further execute a step (not shown) for dividing each of the groups according to the second attribute values.

In addition to the aforesaid steps, the second embodiment can also execute all the operations and functions set forth in the first to third examples in the first embodiment. How the second embodiment executes these operations and functions will be readily appreciated by those of ordinary skill in the art based on the explanation of the first to third examples in the first embodiment, and thus will not be further described herein.

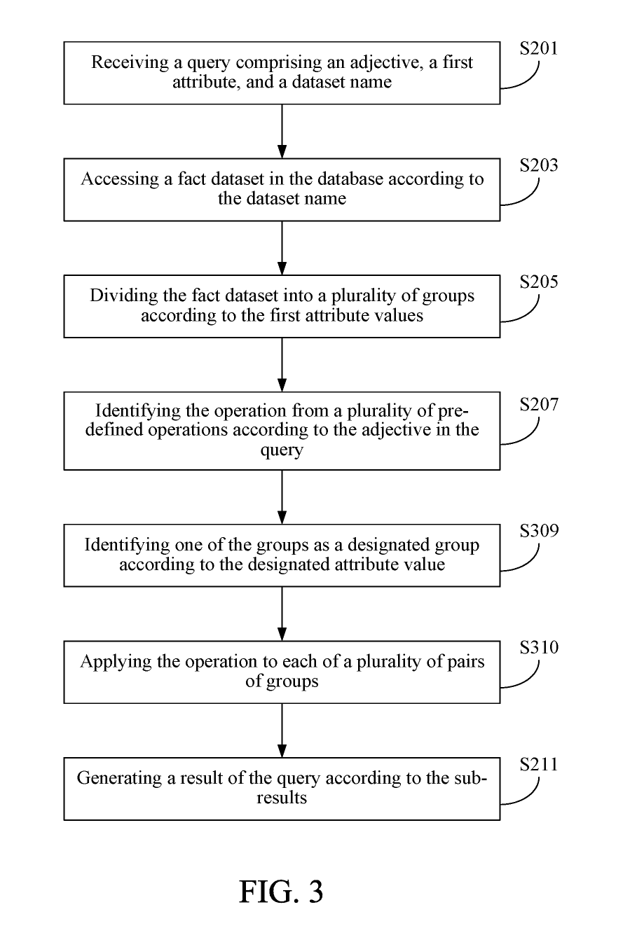

A third embodiment of the present invention is a method for querying a database and a flowchart of which is illustrated in FIG. 3. The method is for use in an electronic apparatus, such as the database querying apparatus 1 in the first embodiment. The database may be stored in the database querying apparatus 1 or a space external to the database querying apparatus 1. Most steps in the third embodiment and those in the second embodiment are similar. Therefore, the following descriptions will focus on the difference of the two embodiments.

The method of the third embodiment also executes step S201 to step S207. It is noted that the query received in step S201 comprises an adjective, a first attribute, a designated attribute value, and a dataset name. The designated attribute value is one of the first attribute values. For example, the content of the query may be “find 2 similar product in gender with “Product5” from xyz,” wherein the adjective is “similar,” the designated quantity is 2, the first attribute is “product,” the second attribute is “gender,” the designated attribute value is “Product5,” and the dataset name is “xyz.”

Afterwards, the method of the third embodiment applies an operation to each group to derive a list of sub-results, wherein the operation corresponds to the adjective. To be more specific, step S309 is executed by the electronic apparatus for identifying one of the groups as a designated group according to the designated attribute value. Following that, step S310 is executed by the electronic apparatus for applying the operation to each of a plurality of pairs of groups, wherein each pair of the groups is formed by the designated group and one of the rest groups. Next, step S211 is executed by the electronic apparatus for generating the final result for the query from the sub-results.

In addition to the aforesaid steps, the third embodiment can also execute all the operations and functions set forth in the fourth example in the first embodiment. How the third embodiment executes these operations and functions will be readily appreciated by those of ordinary skill in the art based on the explanation of the fourth example in the first embodiment, and thus will not be further described herein.

The methods for querying a database in the second and third embodiments may be implemented as a computer program. When the computer program is loaded into an electronic apparatus, a plurality of codes comprised in the computer program are able to perform method for querying a database of the second and third embodiments. This computer program may be stored in a non-transitory tangible machine-readable medium, such as a read only memory (ROM), a flash memory, a floppy disk, a hard disk, a compact disk (CD), a mobile disk, a magnetic tape, a database accessible to networks, or any other storage media with the same function and well known to those skilled in the art.

According to the above descriptions, the present invention provides database querying apparatuses, methods for querying a database, and non-transitory tangible machine-readable media thereof that a query is achieved by an adjective. Generally speaking, a query in the present invention comprises at least an adjective, an attribute, and a dataset name. Depending on the user's requirement, a query may further comprise other attribute(s), a designated quantity, a designated attribute value, etc. Since adjectives are straightforward to human being, it is intuitive and easy for a user to specify adjective-describing query to find out the insight of the data stored in a database.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A database querying apparatus, comprising:
a transceiving interface, being configured to receive a query, wherein the query comprises an adjective, a first attribute, and a dataset name;
a storage unit, being stored with a fact dataset, wherein the fact dataset is defined with the first attribute and at least one data field, the fact dataset comprises at least one fact record, each of the at least one fact record comprises a first attribute value corresponding to the first attribute and a list of data corresponding to the at least one data field; and
a processor, being electrically connected to the storage unit and the transceiving interface and configured to access the fact dataset according to the dataset name, divide the fact dataset into a plurality of groups according to a mapping of the first attribute values one-on-one, apply an operation to each group to derive a list of sub-results, and generate a final result for the query from the sub-results;
wherein the operation corresponds to the adjective.

2. The database querying apparatus of claim 1, wherein the adjective is defined by a function of one of a data pattern and a logical expression of pre-defined adjectives, the operation corresponding to the adjective is one of the function and the defined expression, the function takes a group of data as input and computes and returns a value, wherein the value is one of a Boolean, an integer, and any measurable value, and the logical expression includes one of an AND, OR, NOT, and comparison operators and the combination thereof.

3. The database querying apparatus of claim 1, wherein the query further comprises a designated quantity, each of the sub-results comprises a value, the processor generates the result according to the designated quantity and the values, the result comprises a plurality of selected attribute values, each of the selected attribute values is one of the first attribute values, and a quantity of the selected attribute values is equal to the designated quantity.

4. The database querying apparatus of claim 1, wherein the query further comprises a second attribute, the fact dataset is further defined with the second attribute, each of the at least one fact record comprises a second attribute value corresponding to the second attribute, and the processor further divides each of the groups into a plurality of subgroups according to the second attribute values and while applying the operation corresponding to the adjective to each group, the operation uses the subgroups of the group to derive the sub-result.

5. The database querying apparatus of claim 1, wherein the processor applies the operation to each of the groups and each of the sub-results is derived from one of the groups.

6. The database querying apparatus of claim 1, wherein the query further comprises a designated attribute value, the designated attribute value is one of the first attribute values, and the processor applies the operation by identifying one of the groups as a designated group according to the designated attribute value and applying the operation to each of a plurality of pairs of groups, wherein each pair of the groups is formed by the designated group and one of the rest groups.

7. The database querying apparatus of claim 1, wherein the processor further identifies the operation from a set of pre-defined operations according to the adjective.

8. A method for querying a database, the method being for use in an electronic apparatus and comprising the following steps of:
(a) receiving a query, wherein the query comprises an adjective, a first attribute, and a dataset name;
(b) accessing a fact dataset in the database according to the dataset name, wherein the fact dataset is defined with the first attribute and data field, the fact dataset comprises at least one fact record, each of the at least one fact record comprises a first attribute value corresponding to the first attribute and a list of data corresponding to the at least one data field;
(c) dividing the fact dataset into a plurality of groups according to the first attribute values so that the groups correspond to a mapping of the first attribute values one-on-one;
(d) applying an operation to each group to derive a list of sub-results, wherein the operation corresponds to the adjective; and
(e) generating a final result for the query from the sub-results.

9. The method of claim 8, wherein the adjective is defined by a function of one of a data pattern and a logical expression of pre-defined adjectives, the operation corresponding to the adjective is one of the function and the defined expression, the function takes a group of data as input, computes and returns a value, wherein the value is one of a Boolean, an integer, and any measurable value, and the logical expression includes one of an AND, OR, NOT, and comparison operators and the combination thereof.

10. The method of claim 8, wherein the query further comprises a designated quantity, each of the sub-results comprises a value, the step (e) generates the result according to the designated quantity and the values, the result comprises a plurality of selected attribute values, each of the selected attribute values is one of the first attribute values, and a quantity of the selected attribute values is equal to the designated quantity.

11. The method of claim 8, wherein the query further comprises a second attribute, the fact dataset is further defined with the second attribute, each of the at least one fact record comprises a second attribute value corresponding to the second attribute, and the method further comprises the following step of:
dividing each of the groups into a plurality of subgroups according to the second attribute values;
wherein while applying the operation corresponding to the adjective to each group, the operation uses the subgroups of the group to derive the sub-result.

12. The method of claim 8, wherein the operation is applied to each of the groups in the step (d) and each of the sub-results is derived from one of the groups.

13. The method of claim 8, wherein the query further comprises a designated attribute value, the designated attribute value is one of the first attribute values, and the step (d) comprises the following steps of:
identifying one of the groups as a designated group according to the designated attribute value; and
applying the operation to each of a plurality of pairs of groups, wherein each pair of the groups is formed by the designated group and one of the rest groups.

14. The method of claim 8, further comprising the following step of:
identifying the operation from a set of pre-defined operations according to the adjective.

15. A non-transitory tangible machine-readable medium, being stored with a computer program, the computer program comprising a plurality of codes, the codes being able to execute a method for querying a database when the computer program is loaded into an electronic apparatus, the method comprising the steps of:
(a) receiving a query, wherein the query comprises an adjective, a first attribute, and a dataset name;
(b) accessing a fact dataset in the database according to the dataset name, wherein the fact dataset is defined with the first attribute and at least one data field, the fact dataset comprises at least one fact record, each of the at least one fact record comprises a first attribute value corresponding to the first attribute and a list of data corresponding to the at least one data field;
(c) dividing the fact dataset into a plurality of groups according to a mapping of the first attribute values one-on-one;
(d) applying an operation each group to derive a list of sub-results, wherein the operation corresponds to the adjective; and
(e) generating a final result for the query from the sub-results.

16. The non-transitory tangible machine-readable medium of claim 15, wherein the adjective is defined by a function of one of a data pattern and a logical expression of pre-defined adjectives, the operation corresponding to the adjective is one of the function and the defined expression, the function takes a group of data as input, computes and returns a value, wherein the value is one of a Boolean, an integer, and any measurable value, and the logical expression includes one of an AND, OR, NOT, and comparison operators and the combination thereof.

17. The non-transitory tangible machine-readable medium of claim 15, wherein the query further comprises a designated quantity, each of the sub-results comprises a value, the step (e) generates the result according to the designated quantity and the values, the result comprises a plurality of selected attribute values, each of the selected attribute values is one of the first attribute values, and a quantity of the selected attribute values is equal to the designated quantity.

18. The non-transitory tangible machine-readable medium of claim 15, wherein the query further comprises a second attribute, the fact dataset is further defined with the second attribute, each of the at least one fact record comprises a second attribute value corresponding to the second attribute, and the method further comprises the following step of:
dividing each of the groups into a plurality of subgroups according to the second attribute values;
wherein while applying the operation corresponding to the adjective to each group, the operation uses the subgroups of the group to derive the sub-result.

19. The non-transitory tangible machine-readable medium of claim 15, wherein the operation is applied to each of the groups in the step (d) and each of the sub-results is derived from one of the groups.

20. The non-transitory tangible machine-readable medium of claim 15, wherein the query further comprises a designated attribute value, the designated attribute value is one of the first attribute values, and the step (d) comprises the following steps of:
identifying one of the groups as a designated group according to the designated attribute value; and
applying the operation to each of a plurality of pairs of groups, wherein each pair of the groups is formed by the designated group and one of the rest groups.

21. The non-transitory tangible machine-readable medium of claim 15, wherein the method further comprises the following step of:
identifying the operation from a set of pre-defined operations according to the adjective.
